(19) United States
(12) Patent Application Publication
(10) Pub. No.: US 2021/0200237 A1
(43) Pub. Date: Jul. 1, 2021

(54) FEATURE COVERAGE ANALYSIS

(71) Applicant: Lyft, Inc., San Francisco, CA (US)

(72) Inventor: Robert Kesten, London (GB)

(73) Assignee: Lyft, Inc., San Francisco, CA (US)

(21) Appl. No.: 16/732,096

(22) Filed: Dec. 31, 2019

(51) Int. Cl. G05D 1/02; G06K 9/00

(52) U.S. Cl. CPC G05D 1/0274; G06K 9/00791; G05D 1/0246

(57) ABSTRACT

The present invention relates to a method for evaluating map quality in relation to the suitability of the map for visual localization. More particularly, the present invention relates to a method for providing feedback for identifying where maps need improvement and/or deciding when a map is of sufficient quality to perform localization.

According to a first aspect, there is provided a method comprising one or more landmarks, the method comprising: determining and/or receiving a first area within the map which describes where one or more localization probabilities are to be estimated; determining one or more relevant landmarks at each of one or more positions, each of the one or more positions being within the first area; determining one or more matching probabilities for each of the one or more positions, wherein each of the matching probabilities comprises one or more estimates of a probability of successfully localising within the map using each relevant landmark; and combining the one or more matching probabilities per position into the localization probability per position.

### FIELD OF THE INVENTION

The present invention relates to a method for evaluating map quality in relation to the suitability of the map for visual localization. More particularly, the present invention relates to a method for identifying and/or deciding when a map is of sufficient quality to perform localization.

### BACKGROUND

Building digital maps of a physical environment, such as a city, can provide significant utility to users. This practice is conventionally referred to as digital cartography.

Digital maps can be formed from a compilation of relevant data, and can then be provided to users, for example through a mobile ‘phone interface. To maximise their effectiveness, digital maps may be substantially accurately correlated to the real-world environment which they are seeking to represent.

Localization is the process of using a digital map to identify a location of a device within that map, for example using sensor data from the device.

### SUMMARY

Aspects and/or embodiments seek to provide a measure of the suitability of a map for localization. In particular, the method disclosed herein allows for evaluation of map quality in regards to the probability of effective localization.

According to a first aspect, there is provided a method comprising one or more landmarks, the method comprising: determining and/or receiving a first area within the map which describes where one or more localization probabilities are to be estimated; determining one or more relevant landmarks at each of one or more positions, each of the one or more positions being within the first area; determining one or more matching probabilities for each of the one or more positions, wherein each of the matching probabilities comprises one or more estimates of a probability of successfully localising within the map using each relevant landmark; and combining the one or more matching probabilities per position into the localization probability per position.

According to a further aspect there is provided a computer program product operable to perform the method comprising: determining and/or receiving a first area within the map which describes where one or more localization probabilities are to be estimated; determining one or more relevant landmarks at each of one or more positions, each of the one or more positions being within the first area; determining one or more matching probabilities for each of the one or more positions, wherein each of the matching probabilities comprises one or more estimates of a probability of successfully localising within the map using each relevant landmark; and combining the one or more matching probabilities per position into the localization probability per position.

According to a further aspect there is provided a system operable to perform the method comprising: determining and/or receiving a first area within the map which describes where one or more localization probabilities are to be estimated; determining one or more relevant landmarks at each of one or more positions, each of the one or more positions being within the first area; determining one or more matching probabilities for each of the one or more positions, wherein each of the matching probabilities comprises one or more estimates of a probability of successfully localising within the map using each relevant landmark; and combining the one or more matching probabilities per position into the localization probability per position

A computer may perform the method as disclosed herein in a distributed manner or as part of a system of computers operating in a parallel or distributed fashion.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF DRAWINGS

Embodiments will now be described, by way of example only and with reference to the accompanying drawings having like-reference numerals, in which:

FIG. 1 shows a very high-level representation of a map and how it relates to images taken of the mapped environment and how to perform visual localization;

FIG. 2 shows an example of an object in an environment and three angles from which an image of the object, a house, may be captured;

FIG. 3 shows an overhead view showing the different positions used by the cameras of FIG. 2;

FIG. 4 shows localization performed using multiple landmarks and/or features;

FIG. 5 shows localization performed from different positions using common features;

FIG. 6 shows localization from multiple positions having a common orientation;

FIGS. 7a and 7b show how different trajectories across an environment obtain data having different fields of view;

FIG. 8 shows an example grouping of data for a plurality of specific locations; and

FIG. 9 shows an example representation of localization likelihood at different areas within a map in the form of a heat map.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

A map is a depiction of information about an environment which emphasises the relationships between elements in space such as objects, landmarks, road signs, road names, or location. In some embodiments, a map of a road network may display transport links and include points of interest, such as prominent buildings, tourism sites, recreational facilities, and airports. In some embodiments, maps or sections of a map may be dynamic and/or interactive. Manual input may be used to adjust, correct, or update sections or whole of the map in some embodiments.

In some embodiments, the map may be viewed using a user interface and may be shown as a variety of forms such as a topological map in the form of a schematic diagram, a multi-layer map, or a single corrected and substantially optimised global map or section of the map. In some embodiments, maps are used by robots, vehicles or autonomous vehicles/platforms, for example for navigation.

A landmark (also referred to as a localization landmark) may be defined as any feature (for example of an image or derived from an image) that can be used to perform a localization process. Landmarks may comprise a visual identifier; a semantic identifier; a descriptor; an image descriptor; a lane marker on a road; a feature of a building; a 3D position, a known signature of a feature of a map; and/or a description that helps to reidentify a particular point in an image. The description may include a semantic indicator or an image descriptor of a feature.

A digital map may be divided into a plurality of individual sections, for example where each section may comprise a single position, a grid or other sub-division (by fixed or variable sized area). A sub-division may be relatively smaller for an area with high complexity versus another area with low complexity.

The map area is typically divided up into a grid, each element of the grid being a position within the map, and the centres of each of these grid elements can be between 1 and 10 meters from each other.

Referring to the Figures, an embodiment will now be described.

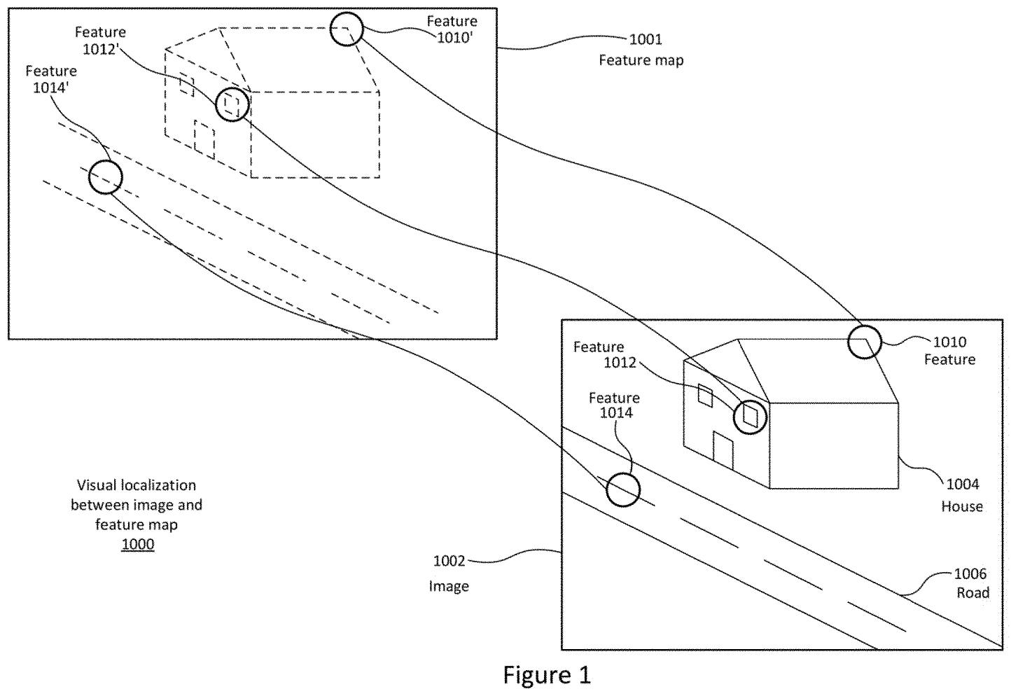

There is shown in FIG. 1 a representation 1000 of how visual localization is enabled. Visual localization in this context refers to a process of estimating the geographical location on a map at which an image 1002 was captured. The example image 1002 includes a house 1004 and a road 1006. The image 1002 is digitally processed and one or more features extracted. The dotted lines represent landmarks in a feature map 1001 that can be correlated to the extracted features of the image 1002. In this example, three landmarks 1010′, 1012′, 1014′ can be matched to corresponding real-life parts of the image 1010, 1012, 1014. The location and relative positions in the map of the landmarks 1010′, 1012′, 1014′ may then be used to identify the location on the map from which the image 1002 was captured.

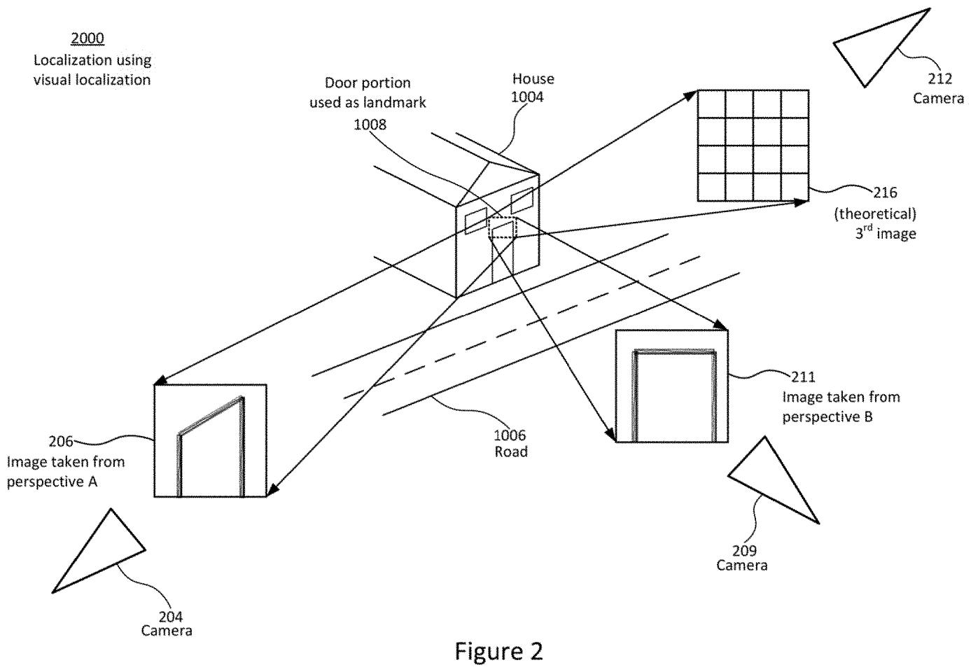

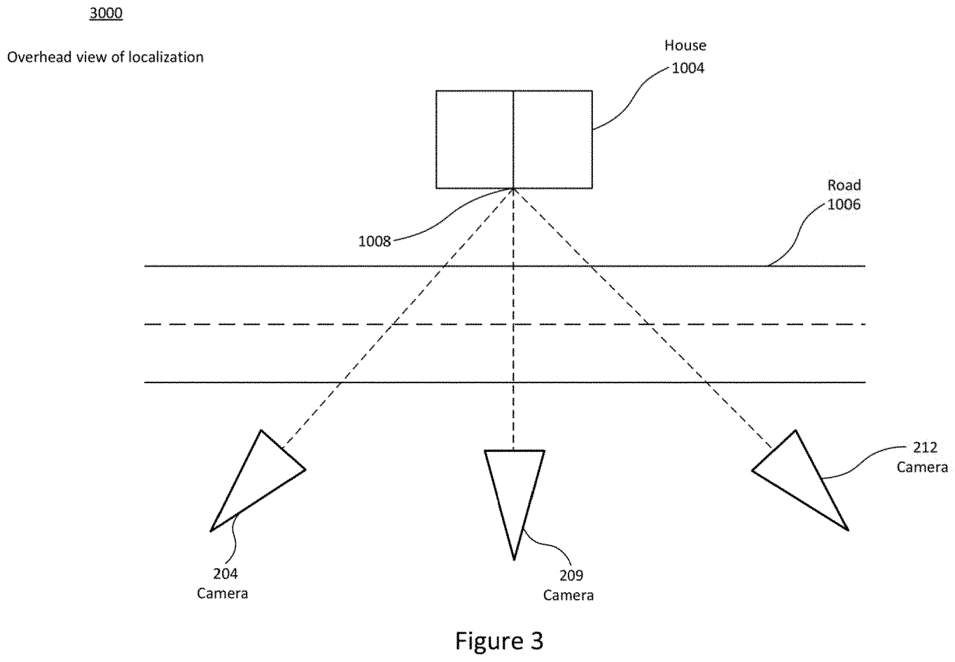

FIG. 2 shows localization performed at multiple positions using visual localization 2000, showing how different views of the same physical object are obtained from different positions around the object. FIG. 3 shows the same situation but as an overhead view 3000.

A descriptor describes the feature(s) of a landmark. A landmark in this context refers generally to a point or area on a visible surface within a real-world setting, for example a very specific section/area of a wall of a building. Each landmark may have a plurality of different descriptors from different angles, and in some embodiments pixels around an image of the landmark. Each landmark is also associated with a specific location.

A first descriptor represents the landmark visible in an image 206 of the view including the landmark from a first location by a first camera 204. Within the first descriptor can be seen a representation of the feature(s) of the landmark, and in some embodiments the descriptor can include details of the pixels surrounding the landmark. There is also shown a second image 211 taken from a second location from a second camera 209. A second descriptor represents the features of the landmark, and in some embodiments the descriptor includes details of pixels surrounding the landmark. The first and second descriptors will differ because the view of the landmark will be different from the different locations from which the images were captured.

For illustrative purposes, there is provided a theoretical third image 216, as may be taken with a third camera 212. This image 216 would be represented with a third descriptor in the map if data from the third position had been used to build the map. In this example, the map data does not include a descriptor for the view of the landmark 1008 from the third position. A matching probability model is used to assess how likely the image from the third position can be matched to any of the known first or second descriptors, and hence whether this third image can be used for successful localization.

If the third descriptor is not known, then the image features can be used to improve the map. However, it is not currently practicable to have descriptors of all possible views.

As each image from each view will be different, the likelihood of localization from each view will vary depending on how similar the features of that view are to a known descriptor. From positions very close to the known first and second views, the likelihood of localization will be high, as the features of resulting images will correspond to the features of existing descriptors. However, from the third position, the likelihood of localization may be lower, as descriptors of the landmark viewed from that direction have not been added to the map.

A descriptor can be a reliable and efficient means to determine the quality of a given landmark and the extent to which it can be used from a variety of positions on the map to localize. The identification of the landmark and the completeness of the descriptor in terms of the number of observation positions from which the descriptor has been generated for that landmark can therefore be used to determine an accurate probability metric for localization, as the likelihood of a landmark being useful for accurate localization in part is determined by the quality of the descriptor for that landmark (for example, to enable localization from multiple viewpoints using that landmark). In some embodiments, occlusions may influence the matching probability. Occlusions may be taken into account in the matching probability model.

In FIGS. 2 and 3, the real-world example of a house 1004 and a relevant road 1006 are shown being captured from different positions by different cameras. In this example, the landmark is a portion of a door 1008. A first image 206 represents an image taken from perspective A by camera 204 from a first location. There is also shown a second image 211, which also shows the door landmark 1008 captured from perspective B by camera 209, which is a different perspective from perspective A from camera 204. A theoretical third image 216 is also represented, which shows the door landmark 1008 captured from perspective C by camera 212, which is a different perspective from perspective A from camera 204 and also a different perspective from perspective B from camera 209.

The respective descriptors generated from the first, second and third images 206, 211, 216 can be used to generate descriptors for a map. The probability of localization at each of the positions using the map will be high, as images taken from each position will have features identical to those of one of the three descriptors.

The probability of localization using an image taken from a camera near one of the cameras 204, 209, 212, from a perspective similar to one of the perspectives A, B, or C is also high, as images taken from such a position will have features similar to those of one of the existing descriptors.

The probability of localization using an image taken from a camera remote from one of the cameras 204, 209, 212, from a perspective dissimilar to one of the perspectives A, B, or C is lower, as images taken from such a position will not match the features of one of the existing descriptors.

Where the probability metric is a value that can be visually represented, for example as a color indicative of the value (for example a high probability can be represented by a green color while a low probability can be represented by a red color), then this visual representation can be overlaid on a two-dimensional overhead view of the map to indicate which positions on the map have high probabilities of localization versus which portions of the map have low probabilities of localization, for one or many views from each position.

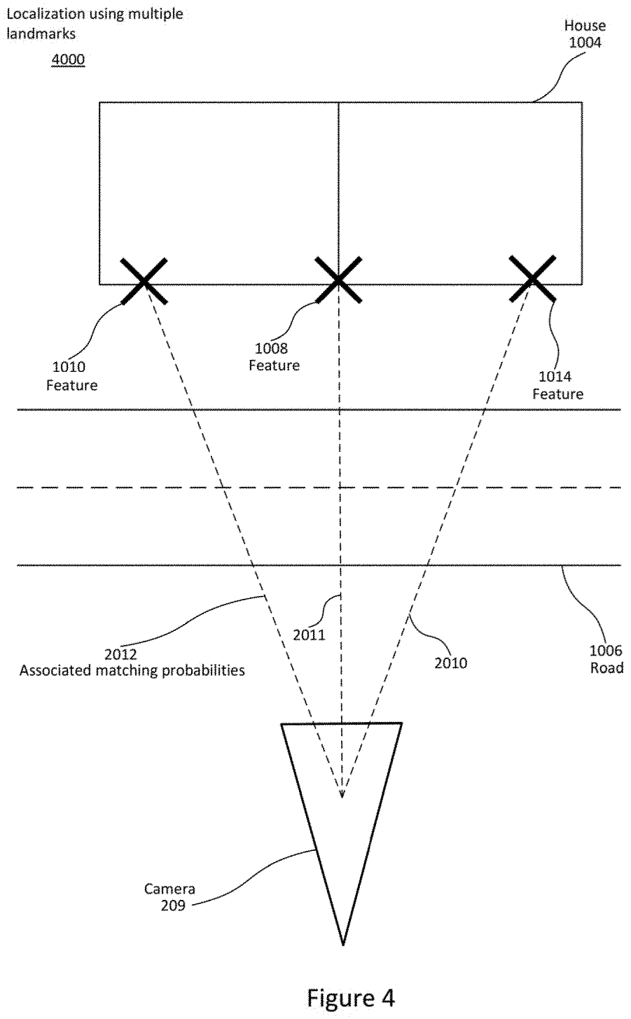

FIG. 4 shows localization using multiple landmarks 4000. There is provided a camera 209, which captures an image. The image comprises details of three landmarks 1008, 1010, 1014 of a house 1004. The features of the image captured by the camera 209 are used as part of a visual localization process, and, for each landmark, a respective matching probability 2011, 2012, 2010 is calculated. The matching probability is the probability that a captured feature can be used for localization against a given landmark (given particular viewing conditions).

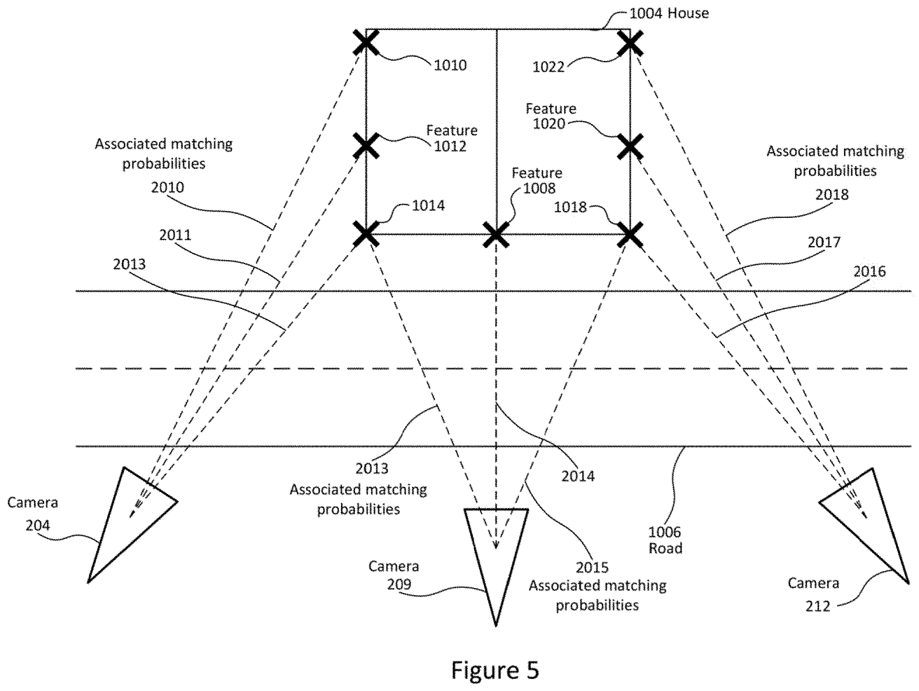

FIG. 5 shows localization from different positions using common features. In this example, three cameras 204, 209, 212 are used to capture a selection of features 1008, 1010, 1012, 1014, 1018, 1020, 1022. Each image captured by each of the three cameras 204, 209, 212 captures features that can be correlated to one or more of the known landmarks depending on the field of view of the camera and therefore which landmarks are visible. Matching probabilities 2010-2018 are calculated for each landmark that is visible to each camera 204, 209, 212. Some landmarks may be visible to more than one camera. Some landmarks may not be visible to one or more of the cameras. In this example, landmark 1014 is within the field of view of two cameras 204, 209 and is therefore present as a feature of the images of both of these cameras. The fields of view of each camera thus record different combinations of features which can be used to localise each of the cameras within the map depending on which combination of landmarks are visible, and what descriptor of the landmark matches the visible features.

The method disclosed herein may make use of a localization success prediction model. The success prediction model comprises a matching probability model, first and second inputs to the matching probability model, and a probability which is output.

An exemplary high-level methodology around the use of a matching probability model comprises the matching probability model receiving two inputs, a first input comprising information about a landmark, and a second input comprising viewing condition data.

A matching probability model is a software model suitable for estimating the probability of matching a landmark that should be visible for a given view at a given position using features derived from sensor data and descriptor(s) for the landmark in the map data.

Within the area of interest, the observation positions from which the landmarks were observed to create the descriptors in the map provide known localized positions. At these known localized positions, it follows that localization has a very high probability using the observed landmarks. In contrast, at positions moving away from these observation/known localized positions it becomes less likely that localization occurs accurately as the change in visual similarity of the features observed compared to the descriptor features decreases the likelihood of a successful match. Thus, one or more probabilities for one or more positions may be calculated at least in part based on the difference in viewing angle between the observation positions encoded in a descriptor of a landmark and the position(s) from which localization using the landmark is being performed. The measure of likelihood of success of localization for a particular position may be provided as a probability.

The first input comprises a descriptor, which is data that describes one or more features of a landmark created from image data taken of the landmark from a specific and recorded viewpoint. The viewpoint from which the image data was taken is encoded in the relevant descriptor for the landmarks. In some embodiments, the first input may further include a descriptor classification, which provides relevant information regarding the landmark to which the descriptor relates: e.g. whether the landmark is part of a tree or a building. The inclusion of such a classification can provide an indication as to how long-lived a landmark is expected to be. A more permanent landmark, for example a section of a wall of a large building, may still relevant for localization in many years. A smaller landmark, for example a portion of a young tree, may change significantly in the future or even be removed altogether.

Therefore the first input includes details of a landmark position and the position(s) from which the landmark was mapped as defined by the descriptor(s) of the landmark.

The second input is the “viewing condition”. The viewing condition is a description of a situation under which a certain landmark is seen, i.e. includes details of anything that influences lighting, or any change in physical appearance over time. Therefore, the viewing condition includes details of the position from which localization is to be performed, including a viewing direction and ambient viewing conditions such as ambient lighting conditions. Other potential factors of influence include one or more of: the time of day; the weather conditions; and/or the age of the landmark. It is appreciated that there are many different potential factors of influence, including any factor which can cause an effect on the lighting and/or physical appearance of the model.

The matching probability model considers one or more of the descriptors for each landmark. For each descriptor, the matching probability model investigates the similarity of viewing conditions when the descriptor was recorded to the viewing conditions under which localization is to be attempted. The more similar the viewing conditions, the more likely the descriptor will be useful for localization. A higher number of descriptors with similar viewing condition leads to a higher probability of successful matching, where matching means that a landmark is successfully associated in the map and thus can be used for localization.

A landmark which has a descriptor which was recorded from a similar position, at a similar time, and under similar weather conditions is more likely to be useful for localization than a landmark which only has descriptors taken from a dissimilar position, at a significantly different time, and/or under different weather conditions.

Based on the first and second inputs provided to the matching probability model, a probability is output. The probability is provided in the form of a number between 0 and 1 (inclusive) and represents a likelihood that the particular landmark of the first input will be visible based on the specific conditions of the second input.

By assessing the localization probabilities using landmarks visible from various positions within a predetermined area, it can be assessed whether the map data for that area, or portions of that area, are of sufficient quality to use for localization. Although the term “area” is used, it will be appreciated that the space within which localization analysis is performed is actually a volume, and alternate terms such as “region” or “zone” may be used in place of the term “area”. Once localization probabilities are assessed, the map may be improved where required by, for example, obtaining further landmark data from which localization may be performed.

A substantially comprehensive test of suitability of map data for localization may be performed across substantially an entire area, rather than performing one or more sparse tests on maps at randomly selected locations using specifically acquired test data.

Maps can be constructed to substantially a threshold localization standard as required, using this method to assess whether the threshold is met, thereby potentially lowering the cost of production or potentially improving the efficiency of mapping and can also prevent maps being constructed inefficiently as it will allow map data gathering to be targeted at regions with insufficient or problematic localization likelihood.

The method disclosed herein can provide a means for assessing how well map data for an area is suited for localization, and in particular how well or how likely a user can perform localization within the area using the map data available. The information provided may include an entire map or one or more portions of a map used to describe the area. The specific metrics of when a map, or a specific subset of it, is “good” can change over time. For example, when the localization algorithm is improved, a previously insufficient map might qualify as good enough. Alternatively, if requirements for “good” localization are tightened, the threshold for acceptable map quality can rise. Further, maps age over time as a physical landscape changes, and as such need to be refreshed over time.

The following criteria may contribute to the likelihood of being able to localise from points on a map using the map data available:
1. Landmarks need to be at a sufficiently correct position.
2. Landmarks need to be relevant. Landmarks that describe temporary objects, with a lifetime typically much shorter than map lifetime do not help localization, instead they can even lead to worse localization. Such temporary objects may include cars, pedestrians, and/or foliage on trees. A determination of whether landmarks can be seen from each being analysed also needs to occur.
3. There needs to be a sufficient landmark coverage. Areas with fewer landmarks may prove difficult to localize within.
4. Landmarks need to have suitable descriptors.

A descriptor is data that describes or defines one or more features of a landmark based on that landmark being identified from image data taken from a specific and recorded viewpoint. The descriptor, or descriptor data, may comprise an artefact generated from a suitable algorithm, which takes image data as an input and outputs the descriptor/descriptor data. The descriptor may be referred to as a feature descriptor and/or a feature vector. Descriptors may be used to encode information into one or more sets of distinct numerical data (i.e. descriptor data) that can be used to differentiate one feature from another. Optionally this descriptor data is invariant under image transformation, which allows for a feature to be identified from the descriptor data even if the image is transformed. For example, a scale-invariant feature transform (SIFT) may be applied, which is operable to encode information about an image gradient as part of the numerical set of the feature vector.

The viewpoint from which the image data was taken is paired with the relevant descriptor to which it relates. More specifically, a visual descriptor describes the visual appearance of a portion of an image in such a way that it can typically be mapped to the same physical entity when seen from a different viewpoint or under different viewing conditions (e.g. different lighting). For example, a scale-invariant feature transform (SIFT) descriptor is commonly used to describe the visual appearance in a small region around a point in an image. Localization can only happen at viewpoints from which landmarks look sufficiently similar to known landmarks.

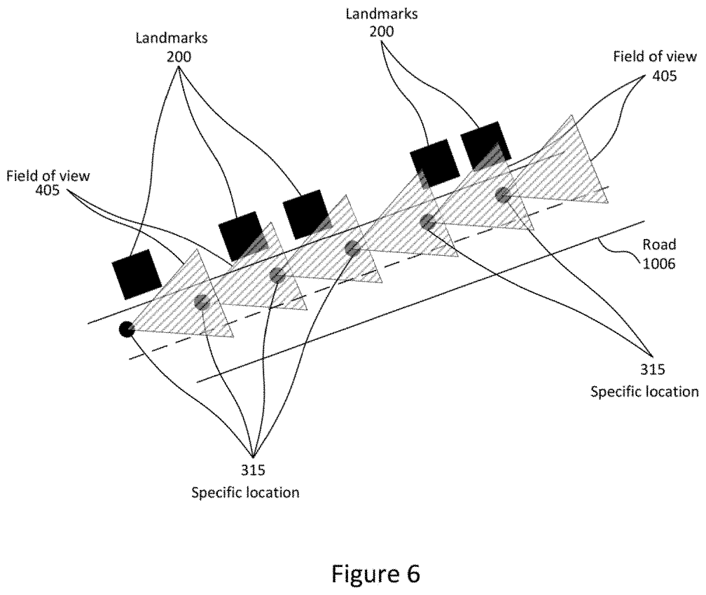

A view of an area is shown in FIG. 6. This area may be chosen through an automatic process according to a method to reduce computational expense of future analysis. However it is appreciated that alternative methods are available, for example selecting an area manually or taking an area from semantic map from which could be obtained specific streets or locations of interest.

As an input, the localization success prediction model requires that an area is defined. This area may be referred to as a “driveable area”, “walkable area”, or a “defined area”, for example when a road network or a park around which users may walk, and within which localization from image data may be performed. A grid may be overlaid on the area, dividing the area into a plurality of smaller areas or locations. The grid may be two dimensional (i.e. the map is viewed from overhead), thereby defining a plurality of smaller areas or individual locations having a fixed height in three dimensional space. In a further embodiment the grid may be three dimensional and discretize a plurality of volumes within the mapped environment.

A series of specific locations 315 within the area of the map shown are selected and processed using the localization success prediction model. The localization success prediction model then provides a prediction of the localization success at each of these locations 315.

For each location 315, a set of local landmarks 200 are potentially available for localization, and may be provided as part of the first input. For each of the locations 315, a determination is made of which of the landmarks 200 can be seen at each location 315. These are the relevant landmarks for each location 315. Relevant viewing conditions are provided as part of the second input into the matching probability model. The resulting output from the localization success prediction model comprises matching probabilities for each of the relevant landmarks 200 for each location 315.

By aggregating the matching probabilities output from the localization success prediction model, a likelihood of localization success is calculated for each location 315. The aggregation may comprise a summing operation or other aggregation means. Once the aggregation is calculated, a localization success score can be assigned to the location 315.

The area comprises a plurality of specific locations 315, as well as a plurality of landmarks 200. Each location 315 has an associated field of view 405, which overlaps with at least one of the landmarks 200. In this example, the fields of view 405 are all facing in the same direction as the example locations 315 are at various successive points along a lane of a road that traffic is obliged to traverse in one specified direction.

When considering the ability to localize within the area, in at least one embodiment two or more different known image views for certain locations are required to assess localization probabilities using the matching probability model. For example, at these certain locations it might be possible to travel in different directions so a view in each possible direction needs to be assessed for localization probability.

For each location 315, it is necessary to determine which landmarks are visible, i.e. which are the relevant landmarks. In some embodiments, a synthetic image is then generated of the field of view 405, comprising all of the landmarks 200 theoretically visible. For each of the visible landmarks 200, relevant data is input to the matching probability model to output a probability of visibility for each landmark 200. This provides an expected value of matches from that particular field of view 405, optionally calculated as a sum of each of the individual probabilities.

For a greater expected value of matches, the higher chance for localization from that particular view using the map data. However, if the expected value of matches is below a predetermined value, then the map data cannot be used sufficiently reliably as a means for localization.

There are a number of options available for representing the expected value of matches for a given set of locations 315. Each location 315 can be assessed across a complete, 360-degree view of its surroundings. However, each slice of that view, for example the slice encapsulated within the field of view 405 of a camera, may have a different localization probability as calculated by the matching probability model. For example, several useful landmarks may be present in one field of view facing north, but no landmarks present in the map data are visible when facing south.

Therefore, when considering how to represent the calculated probability data most effectively, several options are proposed. One option is to select a set of locations 315 in which each relevant field of view 405 is selected as being that with the lowest expected value of matches. Therefore, the locations 315 in which localization may be more difficult are highlighted and remedial action can be taken.

Typically, should there be a high number of landmarks and/or the landmarks visible from a position within an area have high quality localization potential, the localization probability at that point in the map should be higher than if only few landmarks are visible and/or the localization data for the landmarks that are visible is of low quality, so the probability metric can be representative of or correlate with the expected number of relevant landmarks for relevant views at each point within an area.

The expected number of successful matches for localization may comprise an average value across a plurality of view directions. In a further example, aggregate localization probabilities may be collated, or the number of matches of multiple view directions with minimum or mean values calculated.

Some landmarks may change visually as time passes. For example, the colors on a building may become less vivid. By generating an aging metric, optionally wherein the aging metric provides a means for predicting the appearance of a landmark after a predetermined about of time has passed. A landmark might alternatively or additionally become occluded or shaded by other objects that are introduced into the environment. Using long-term and hence more likely to be high-certainty landmarks such as (one or more parts of) buildings as opposed to, for example, more temporary landmarks such as parked cars (which may be moved) can allow map data comprising long-term and high-certainty landmark data to be used for longer into the future.

According to a further example, each relevant field of view 405 for each of the locations 315 is fixed at a predetermined orientation. The resulting data may therefore provide a measure of consistency, especially along a fixed path such as a road 1006.

To find the relative usefulness, the area may be analyzed before being discretized and the localization potential of each location evaluated. The analysis of the area may be performed through the use of an artificial intelligence (AI), optionally through the use of a machine learning (ML) arrangement comprising one or more neural networks.

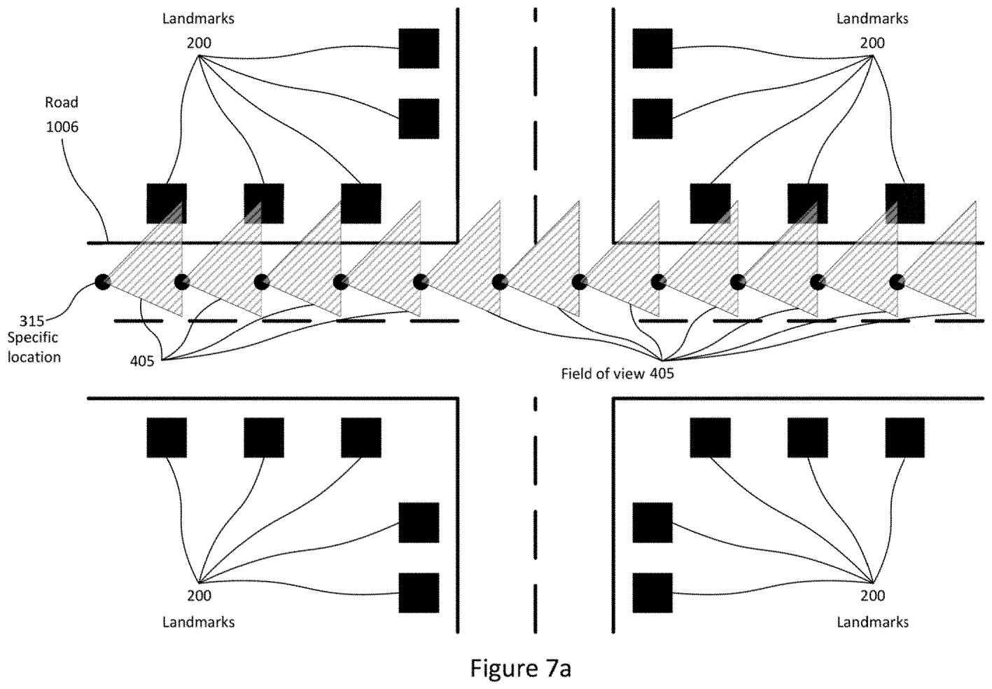

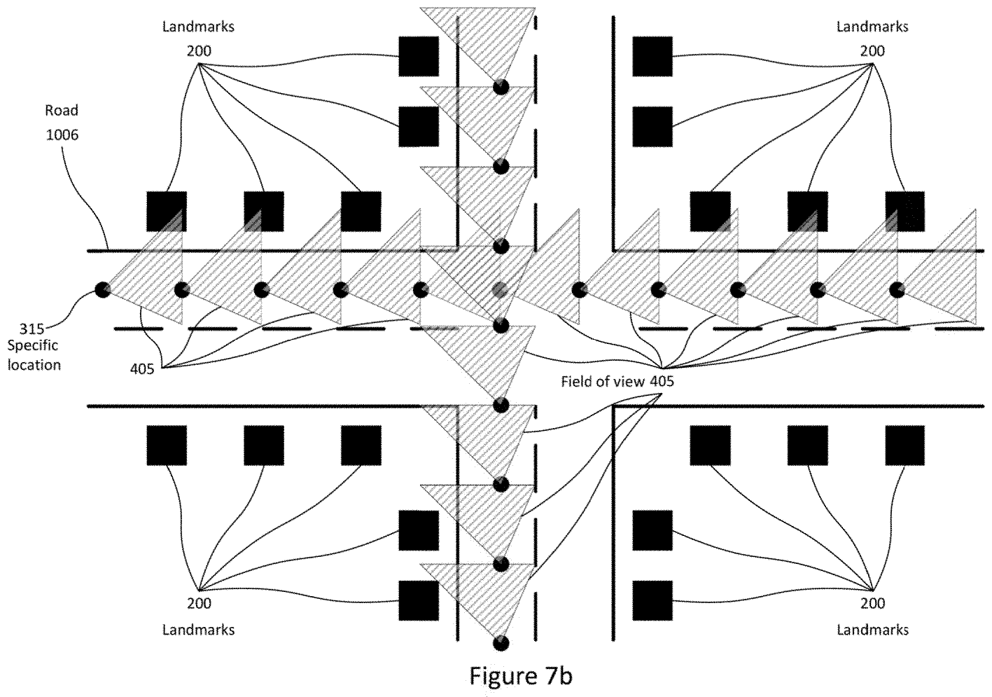

As shown in FIGS. 7a and 7b, a further option for collecting and analysing relevant data may be performed. In this embodiment, each relevant field of view 405 for each of the locations 315 is selected according to the relative usefulness of that field of view 405. In this example, there is provided a road 1006 which has vehicles driving along it in a generally predetermined fashion. Therefore the relevant field of view of each specific location 315, i.e. the successive location of a vehicle travelling along the road 1006 over time, is in a generally consistent direction. FIG. 7a shows such an embodiment, in which the field of view of each specific location 315 is collated at particular points in time. In FIG. 7b, overlap between relevant fields of view are shown where a vehicle drives over an intersection at a different orientation from the first vehicle. Thus for the common locations 315, i.e. the intersection, the relevant field of view for each common location 315 is larger.

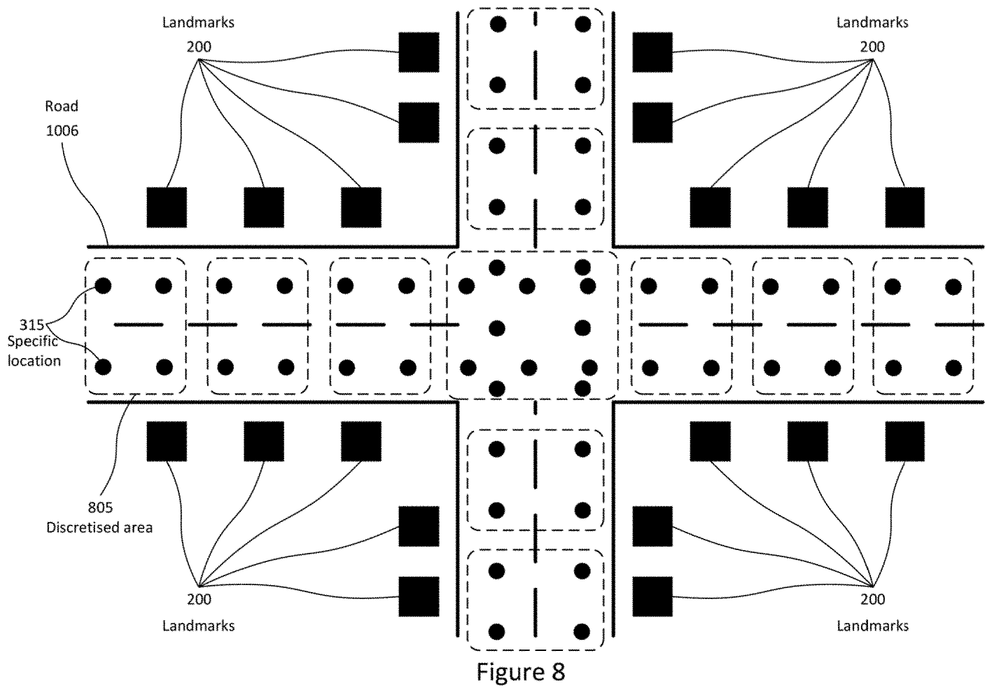

These are the fields of view which are considered relevant when putting together a probability score regarding the localization probability of each location 315 across relevant views, as opposed to the scores which may be generated for a field of view at a location 315, in a less relevant direction. Each of the specific locations 315 may be grouped into a discrete area 805, as shown in FIG. 8. The or each discretized area 805 can then be used as the basis to assign an aggregated probability metric, according to the field of view of each specific location 315 and within each discrete area and more specifically the ability to localize based on the relevant fields of view for each of the specific locations 315.

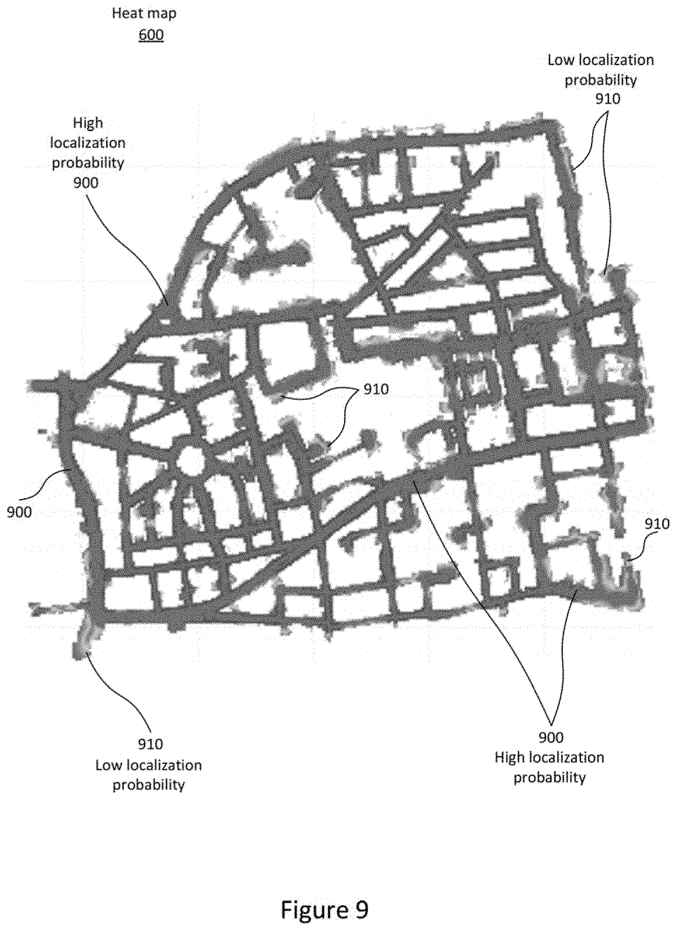

FIG. 9 shows an aggregation of probability metrics from a plurality of positions across an area. Each position within the area is represented by an aggregation of localization probability metrics for that position, for example by combining the localization probability for the different relevant (or all) directional views possible from each particular position into a single value that can be represented visually on a map. Such aggregation may be performed as described herein. The associated probability metrics for each position, which may comprise a plurality of views associated with that position, may be merged into a single scalar value for any given position on a 2D grid. Such aggregation may be performed according to a range of different summing and/or weighting approaches.

A plurality of positions and their associated probability metrics may be aggregated into an aggregation mask 600 in the form of a visual heat map 600 as shown in the Figure. The aggregation mask 600 may comprise information from: multiple overlapping localization attempts such as those extracted from adjacent positions with overlapping views; and/or multiple view directions. In this embodiment, areas with a high localization probability 900 are shown in a darker color, and areas with a low localization probability 910 are shown in a lighter colour. In such a way, the areas in which localization may need to be improved, such as the areas with a low localization probability 910 may be more easily identified and remedial action taken.

Each of the areas selected for determination of localization probability may be first provided to a filtering arrangement. The filtering arrangement is operable to remove one or more irrelevant landmarks from the area, for example removing cars, pedestrians, and/or foliage on trees which may have been captured in one or more images used as descriptors associated with that area. Irrelevant landmarks typically include those objects and actors within an area that do not provide appropriate means for localization, as these objects and actors themselves exist in a specific location for a significantly shorter period of time than the intended lifetime of a useful landmark. For example, the leaves on a tree may change seasonally, and a car may be present on a given street for only a limited period of time ranging from a few seconds to a few days. For consistent localization the landmarks must be of a more permanent status, such as a large building or natural phenomenon. Some types of landmark, however, may introduce errors into the localization process due to dynamic changes to that object. For example, a tree with green foliage in the summer may be used as a landmark. However, in a season other than summer the foliage may change color and fall from the tree thus changing the landmark and potentially decreasing the probability of localization within the map using the data collected about the landmark in the summer. Areas of the map which are capable of being localized with respect to the green foliage may no longer localize correctly at other times of the year. Such a tree can be removed during the filtering stage, and hence the output comprises cleaner data which may be more accurately analyzed with respect to its suitability for localization.

A large portion of irrelevant landmarks may lead to a significant overestimation of the localization quality of a given area. Inaccurate landmarks in this context refers to the ability to localise using a given landmark due to their temporal nature (e.g. a parked car, that will eventually disappear) or due to their dynamic nature (e.g. a tree that has foliage that changes over the seasons). Inaccuracies become particularly relevant when they lead to problems in localization. For example, if the landmarks that are indicated to be available in the given area are too different from what is physically observed, localization results can become inconsistent with features detected in an image. This leads to a portion of “good” matches not being usable for localization.

For each position or zone within a map, the localization probability can be aggregated into a single or complex metric, for example a single numerical value such as 1 indicating very low likelihood for localization and 10 indicating an excellent and reliable localization likelihood. This value might be presented by a contrasting color scheme, for example “red” versus “green” locations within an area.

In one example use of the method, system and apparatus described herein may be used in relation to localizing one or more driverless vehicles. Driverless vehicles may comprise one or more sensors. The one or more sensors may include one or more of: proximity sensors; image sensors optionally including optical character recognition; laser detection systems; a global positioning system (GPS); and/or a LIDAR system.

The one or more image sensors may comprise one or more video cameras. The image sensors are operable to receive image data as an input derived from the view adjacent the driverless vehicle. The image data may then be transmitted to a processor to analyse the image data in accordance with any one or more of the method steps described herein. If the image data comprises a landmark, for example if the vehicle is passing a notable skyscraper, then the map may be localized according to that landmark.

However, in areas which are poorer candidates for localization, fewer landmarks may be observed visually from an image sensor mounted on a driverless vehicle. Therefore, the vehicle may less accurately localize its position. In such environments further work may be required to localize the vehicle with respect to a known map to a sufficient degree of accuracy.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

We claim:

1. A method comprising:
determining a first area within the map which describes where one or more localization probabilities are to be estimated;
determining one or more relevant landmarks at each of one or more positions, each of the one or more positions being within the first area;
determining one or more matching probabilities for each of the one or more positions, wherein each of the matching probabilities comprises one or more estimates of a probability of successfully localising within the map using each relevant landmark; and
combining the one or more matching probabilities per position into the localization probability per position.

2. The method as recited in claim 1, wherein each matching probability is derived from a matching probability model.

3. The method as recited in claim 1, wherein the one or more positions are each separated by a distance of between 0.1 to 20 meters from each of the other one or more positions.

4. The method as recited in claim 1, wherein each position has one or more views; and wherein each view has one or more matching probabilities.

5. The method as recited in claim 4 further comprising determining a combined matching probability per view per position by determining an aggregated value of the one or more matching probabilities of each view per position.

6. The method as recited in claim 5 wherein combining the one or more matching probabilities per position into the localization probability per position comprises combining the one or more combined matching probabilities per position into the localization probability.

7. The method as recited in claim 4 wherein combining the one or more matching probabilities per position into the localization probability per position is performed for all views per position.

8. The method as recited in claim 1, wherein the one or more relevant landmarks are determined per position by determining which of the one or more landmarks are within one or more predetermined fields of view of the respective position.

9. The method as recited in claim 5, wherein the combined matching probability comprises a determination of an expected number of successful localization matches with relevant landmarks from that view from that position.

10. The method as recited in claim 1, wherein each of the localization probabilities per position are output in a visual representation.

11. The method as recited in claim 10, wherein the visual representation comprises a “heat map”.

12. The method as recited in claim 1, wherein the one or more landmarks comprise at least one representation, wherein the representation each comprises a position and any of one or more: feature descriptors; visual identifiers; semantic descriptors; semantic identifiers; descriptors; visual feature descriptors.

13. The method as recited in claim 1, the map further comprising one or more surfaces, the one or more surfaces defining one or more features within the map.

14. The method as recited in claim 13, further comprising determining whether the one or more surfaces are in the line of sight to a relevant landmark.

15. The method as recited in claim 1, wherein each matching probability is dependent on any of: a time of capture, environmental information, a viewing angle.

16. A computer program product operable to perform the method comprising:
determining a first area within the map which describes where one or more localization probabilities are to be estimated;
determining one or more relevant landmarks at each of one or more positions, each of the one or more positions being within the first area;
determining one or more matching probabilities for each of the one or more positions, wherein each of the matching probabilities comprises one or more estimates of a probability of successfully localising within the map using each relevant landmark; and
combining the one or more matching probabilities per position into the localization probability per position.

17. A system operable to perform the method comprising:
determining a first area within the map which describes where one or more localization probabilities are to be estimated;
determining one or more relevant landmarks at each of one or more positions, each of the one or more positions being within the first area; and
determining one or more matching probabilities for each of the one or more positions, wherein each of the matching probabilities comprises one or more estimates of a probability of successfully localising within the map using each relevant landmark; and
combining the one or more matching probabilities per position into the localization probability per position.
